(19) United States
(12) Patent Application Publication
(10) Pub. No.: US 2013/0048921 A1
(43) Pub. Date: Feb. 28, 2013

(54) CONDUCTIVE MATERIAL

(71) Applicants: Yasuo Tsuruoka, Chikusei-shi (JP); Takeshi Nojiri, Tsukuba-shi (JP); Shuuichirou Adachi, Tsukuba-shi (JP); Takahiro Fukutomi, Chikusei-shi (JP); Waka Inoue, Chikusei-shi (JP); Kenzou Takemura, Chikusei-shi (JP); Michio Uruno, Chikusei-shi (JP)

(72) Inventors: Yasuo Tsuruoka, Chikusei-shi (JP); Takeshi Nojiri, Tsukuba-shi (JP); Shuuichirou Adachi, Tsukuba-shi (JP); Takahiro Fukutomi, Chikusei-shi (JP); Waka Inoue, Chikusei-shi (JP); Kenzou Takemura, Chikusei-shi (JP); Michio Uruno, Chikusei-shi (JP)

(73) Assignee: HITACHI CHEMICAL CO., LTD., Tokyo (JP)

(21) Appl. No.: 13/555,347

(22) Filed: Jul. 23, 2012

Related U.S. Application Data
(60) Provisional application No. 61/510,236, filed on Jul. 21, 2011.

(51) Int. Cl. H01B 1/22

(52) U.S. Cl. 252/512

(57) ABSTRACT

A conductive material used for connecting electrodes of a solar battery cell and wiring members, the conductive material comprising a resin binder; and a conductive particle dispersed in the resin binder, wherein the conductive particle comprises a phosphorous-containing copper alloy having a phosphorus content of 0.01% by mass or more and 8% by mass or less.

### CROSS-REFERENCE TO RELATED APPLICATION

This application claims priority to Provisional Application filed on Jul. 21, 2011 by the same Applicant, which is hereby incorporated by reference in its entirety.

### BACKGROUND OF THE INVENTION

1. Field of the Invention

The present invention relates to a conductive material.

2. Related Background Art

In recent years, as a means of solving problems such as worsening global warming and fossil energy depletion, solar batteries have received attention. The solar batteries are usually formed by connecting a plurality of solar battery cells in series or in parallel. On a surface (light-receiving surface) of the solar battery, a plurality of linear electrodes (finger electrodes) composed of Ag for gaining an output power are formed in parallel each other. Further, on a rear surface thereof, a rear surface electrode composed of Al is formed so as to cover the entire surface thereof. Then, among neighboring solar battery cells, to a light-receiving surface of one side solar battery cell, metal wiring members (tab wires) are connected so as to be orthogonal to all finger electrodes, further, these tab wires are connected to a rear surface electrode of other side solar battery cell, and thereby the neighboring solar battery cells are connected to each other. In this connecting, solder, which exerts excellent electrical conductivity, has been hitherto used (Japanese Patent Application Laid-Open No. 2002-263880, Japanese Patent Application Laid-Open No. 2004-204256).

Meanwhile, from the viewpoint of environmental protection and the like, methods of connecting electrodes of a solar battery cell and tab wires without using solder are examined. For instance, methods of electrically connecting electrodes of a solar battery cell to tab wires using a pasty or a film-shaped conductive adhesive (conductive material) are proposed in Japanese Patent Application Laid-Open No. 2000-286436, Japanese Patent Application Laid-Open No. 2001-357897, Japanese Patent Application Laid-Open No. 07-147424, Japanese Patent Application Laid-Open No. 2005-101519, Japanese Patent Application Laid-Open No. 2007-158302, and Japanese Patent Application Laid-Open No. 2007-214533.

### SUMMARY OF THE INVENTION

However, in the case where solder is used in connection of solar battery tab wires, there is a need to connect fine patterns individually, and since about 220° C. or higher heat is applied to solar battery cells, a decrease in yield in a connection step and a limit of space-savings of connection components occur.

Further, when the above-mentioned conductive material is used, these problems can be solved to some extent. As an anisotropic conductive material or a conductive material, a conductive particle primarily containing gold or nickel has been hitherto used for reduction in and stability of connection resistance after connection. With this, miniaturization of devices can be realized and corrosion failure during use can be prevented.

However, when gold is used, there is a problem with an increase in production cost. Further, when nickel is used, there is a problem with an increase in environmental loads. Further, when a conductive particle primarily containing a metal other than these metals is used, it is difficult to obtain a stable connection resistance equivalent to that obtained by the use of nickel, or the like.

The present invention has been made to solve these problems, and an object of the present invention is to provide a conductive material capable of connecting with a stable connection resistance and at low temperature and capable of suppressing an increase in production cost.

The present invention provides a conductive material used for connecting electrodes of a solar battery cell and wiring members, the conductive material comprising a resin binder; and a conductive particle dispersed in the resin binder, wherein the conductive particle comprises a phosphorous-containing copper alloy having a phosphorus content of 0.01% by mass or more and 8% by mass or less.

According to the conductive material, it is possible to perform connecting with a stable connection resistance, at a low temperature, and with a high degree of precision, and to suppress an increase in production cost.

It is preferable that an average particle diameter of the conductive particle be 0.4 μm to 30 μm. Note that the “average particle diameter” as referred to in this description means a particle diameter obtained when an integrated weight of particles occupies 50% (hereinafter, also referred to as “D50”). Furthermore, in point of the particle diameter, when the form of a conductive particle is non-spherical, the particle diameter of the conductive particle is a diameter of minimum sphere circumscribed to conductive particle.

It is preferable that the conductive particle be a conductive particle produced by using a water atomizing method.

Further, the invention may be applied as a conductive material used for connecting electrodes of a solar battery cell and wiring members, the conductive material comprising a resin binder; and a conductive particle dispersed in the resin binder, wherein the conductive particle is a composition comprising a phosphorous-containing copper alloy having a phosphorus content of 0.01% by mass or more and 8% by mass or less, and may be applied for producing a conductive material used for connecting electrodes of a solar battery cell and wiring members from the composition.

According to the present invention, it is possible to provide a conductive material capable of connecting with a stable connection resistance, at a low temperature, and with a high degree of precision and capable of suppressing an increase in production cost.

### BRIEF DESCRIPTION OF THE DRAWINGS

FIG. 1 is a schematic plan view showing a light-receiving surface of a solar battery cell according to one aspect, which can be connected by a conductive material of the present invention;

FIG. 2 is a schematic plan view showing a light-receiving surface of a solar battery cell according to one aspect, which can be connected by a conductive material of the present invention;

FIG. 3 is a schematic plan view showing a light-receiving surface of a solar battery cell according to one aspect, which can be connected by a conductive material of the present invention; and

FIG. 4 is a schematic perspective view showing a state where a plurality of solar battery cells is connected.

### DESCRIPTION OF THE PREFERRED EMBODIMENTS

Hereinafter, one exemplary embodiment of the present invention will be described in detail with reference to drawings. Note that, in the drawings, the same or corresponding parts are provided with the same reference signs, and overlapping explanations are omitted.

A conductive material of the present invention comprises a resin binder and a conductive particle dispersed in the resin binder.

The conductive particle comprises a phosphorous-containing copper alloy containing copper and phosphorous. The phosphorus content of the phosphorous-containing copper alloy is 0.01% by mass or more and 8% by mass or less. With the phosphorus content being 8% by mass or less, a lower resistivity can be achieved, and it becomes excellent in productivity of the phosphorous-containing copper alloy. Further, with the phosphorus content being 0.01% by mass or more, higher oxidation resistance can be achieved. From the viewpoint of oxidation resistance and a low resistivity, the phosphorus content is preferably 0.5% by mass or more and 7.8% by mass or less, and more preferably 1% by mass or more and 7.5% by mass or less. Further, it is more preferable that the phosphorus content be such a phosphorus content that a peak temperature of an exothermic peak indicating a maximum area in a differential thermal-thermogravimetric concurrent measurement is 280° C. or higher.

The phosphorous-containing copper alloy is an alloy containing copper and phosphorous, however, which may further contain other atoms. Examples of the other atoms include Sb, Si, K, Na, Li, Ba, Sr, Ca, Mg, Be, Zn, Pb, Cd, Tl, V, Sn, Al, Zr, W, Mo, Ti, Co, Ni, Au, and the like. Among these, from the viewpoint of adjustments of properties such as oxidation resistance and a melting point, Al is preferred.

Further, in the case where the phosphorous-containing copper alloy contains other atoms, the phosphorus content can be, for example, 3% by mass or less, and from the viewpoint of oxidation resistance and a low resistivity, it is preferable that the phosphorus content be 1% by mass or less.

As a particle diameter of the conductive particle, the average particle diameter (D50) is preferably 0.4 μm to 30 μm, and more preferably 1 μm to 10 μm. With the average particle diameter being 0.4 μm or larger, the oxidation resistance is efficiently enhanced. Further, the average particle diameter being 30 μm or smaller, the long-term connection stability is more efficiently obtained.

Further, the shape of the conductive particle is not particularly limited, and may be any shapes, including nearly spherical, flat, block, plate-like, flake, and the like. From the viewpoint of oxidation resistance and a low resistivity, it is preferable that the shape of the conductive particle be nearly spherical, flat, or plate-like.

The phosphorous-containing copper alloy can be produced by a commonly used method. Further, the conductive particle can be prepared, using a phosphorous-containing copper alloy, which is prepared so as to have a desired phosphorus content, by the use of a common method of preparing a metal powder, for example, by the use of a water atomizing method, according to prescribed procedures. Note that the details of the water atomizing method is described in Kinzoku Binran “Metals Handbook” (Maruzen Co., Ltd. publication division), and the like.

Specifically, for instance, after a phosphorous-containing copper alloy is dissolved and this dissolved alloy is powdered by nozzle atomization, the obtained powder is dried and classified, and thereby a desired conductive particle can be produced. Further, a conductive particle having a desired particle diameter can be produced by appropriately selecting classification conditions.

Further, the conductive particle may be a conductive particle produced from the above-mentioned phosphorous-containing alloy, and with the outside thereof being coated with a metal such as silver, palladium, and gold, or a metal alloy. The metal used for the coating is preferably a metal primarily containing silver, from the viewpoint of costs. As for the coating method, conventional methods such as plating and vapor deposition can be used. The coating thickness is not particularly limited, however, from the viewpoint of costs, it can be 1 μm or less, and more preferably 0.5 μm or less.

Further, these conductive particles may be used alone, two or more types thereof may also be used in combination, or two or more types of conductive particles including conductive particles other than the phosphorous-containing copper alloy may be used in combination.

The conductive particle content of the conductive material can be, for example, from 0.1% by volume to 20% by volume, preferably from 1% by volume to 20% by volume, and more preferably from 1% by volume to 15% by volume. When the conductive particle content is less than 0.1% by volume, the initial value of the connection resistance as a conductive material increases, as compared to the case where the conductive particle content is within the range. Further, when the conductive particle content is more than 20% by volume, the long-term connection stability lowers, as compared to the case where the conductive particle content is within the range.

Furthermore, when the conductive particle content is from 1% by volume to 15% by volume, the long-term connection stability can be further sufficiently exerted, even when bus bars of a solar battery cell are thin or no bus bar is provided (bus bar less) in a solar battery cell, or even when no bus bar is provided in a solar battery cell and finger electrodes are thin.

The resin binder is not particularly limited as long as it exerts adhesion, however, from the viewpoint of further enhancing the adhesion, it is preferable that the resin binder be a resin composition containing a thermosetting resin.

As the thermosetting resin, a known thermosetting resin can be used, and examples thereof include epoxy resins, phenoxy resins, acrylic resins, polyimide resins, polyamide resin, and polycarbonate resins. These thermosetting resins may be used alone or two or more types may be used in combination. Among these, from the viewpoint of further enhancing connection reliability, one or more types of thermosetting resins selected from the group consisting of epoxy resins, phenoxy resins and acrylic resins are preferred.

Further, the resin composition as an adhesive component may contain a known hardening agent and a known hardening accelerator as optional components, besides the thermosetting resins.

Further, in order to improve the adhesion and the wettability to an adherend, this resin composition may contain modifiers such as a silane coupling agent, a titanate coupling agent, and an aluminate coupling agent, and in order to improve the uniform dispersibility of the conductive particle, it may contain dispersants such as calcium phosphate, calcium carbonate, and the like.

Further, in order to control the elastic modulus and the tackiness, this resin composition may contain rubber components such as acrylic rubber, silicon rubber, and urethane, and in order to inhibit migration of metals contained in an adherend, and metals (particularly, silver and copper) contained in the conductive particle, this resin composition may contain chelate materials, and the like.

In the conductive material, one type or two or more types of different additives, for example, an extender, a softener (plasticizer), a tackiness/adhesion improver, an antioxidant (age resister), a heat stabilizer, a light stabilizer, a ultraviolet absorber, a coloring agent, a flame retardant, and an organic solvent may be mixed as required, in addition to the above-mentioned resin binders and conductive particles, within the range not impairing the achievement of the object of the present invention.

The form of the conductive material is not particularly limited. Specific examples thereof include (anisotropic) conductive pastes, (anisotropic) conductive inks, (anisotropic) conductive tacky adhesive agents, (anisotropic) conductive films, and (anisotropic) conductive sheets.

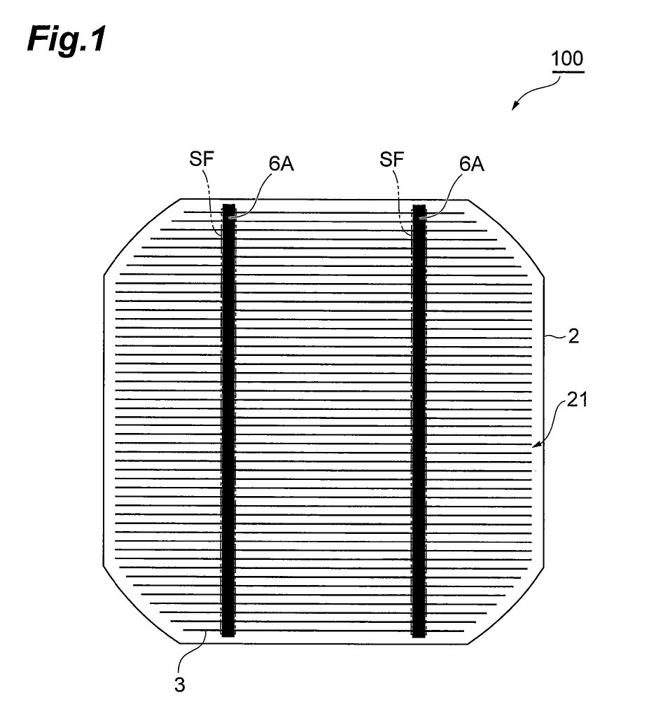

FIGS. 1 to 3 are schematic plan views showing light-receiving surfaces of solar battery cells connectable by the conductive material of the present invention.

As shown in FIG. 1, a solar battery cell 100 has a substrate 2, and is the one that a plurality thereof are electrically connected in series or in parallel to form one solar battery module. This substrate 2 takes on the semblance of a nearly square, and four corners thereof are arc-shaped. One side surface of the substrate 2 is a light-receiving surface 21. The substrate 2 is composed, for example, of at least one of a silicon monocrystal cell, a polycrystal cell, an amorphous silicon cell or a heterojunction cell. The substrate 2 may be, on the side of the light-receiving surface 21, an n-type semiconductor or a p-type semiconductor. In the substrate 2, for instance, the distance between opposing two sides is 125 mm.

On the surface of the light-receiving surface 21, a plurality (for example, 48 pieces) of linear finger electrodes 3 are arranged in parallel with a distance from each other. Further, bus bars 6A are arranged so as to be orthogonal to the finger electrodes 3. The finger electrodes 3 and bus bars 6A are formed of a metal paste such as silver, an electrodeposition conductive film, a conductive thin film, or the like.

In the case where such solar battery cells 100 are connected using the above-mentioned conductive material, the conductive material is placed in bonding areas SF, and a wiring member is further placed thereon. Further, when necessary, heating and pressuring may be performed thereon. Examples of conditions for the heating and pressuring include heating: 140° C. to 220° C. for one minute to 30 minutes, and pressuring: 0.1 MPa to 0.3 MPa.

Note that when the conductive material is in the form of a liquid, the conductive material may be applied and placed by dispensing, screen printing, stamping, or the like.

The wiring member (tab wire) is not particularly limited. Specifically, it is possible to use a tab wire, etc. in which a surface of a ribbon having a thickness of 0.1 mm to 0.4 mm, a width of 0.5 mm to 10.0 mm and primarily containing copper is coated with leaded solder, lead-free solder, silver, tin, or the like. It is also possible to use a tab wire which is of the type that the form of a surface thereof is made to be a light diffusion surface, and sunbeams applied to the tab wire are diffuse-reflected and re-reflected at an interface between a glass of a solar battery module and atmosphere.

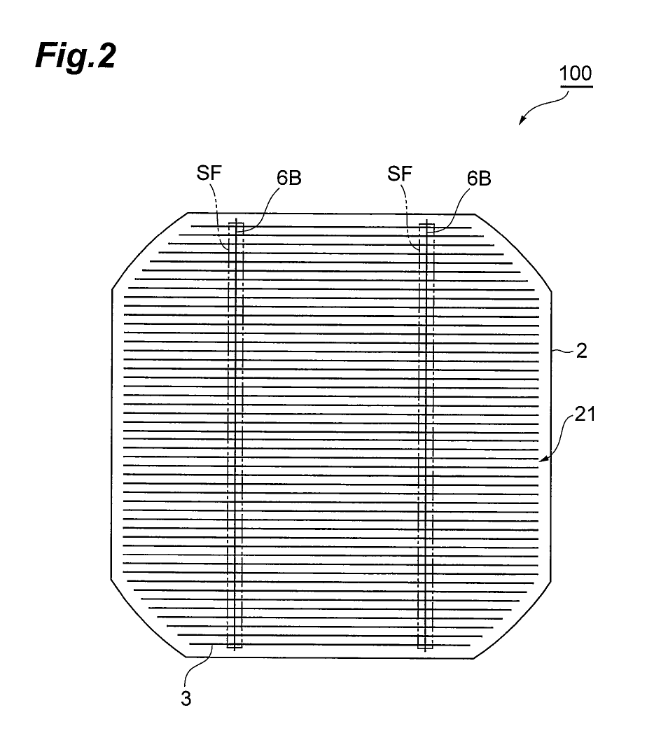

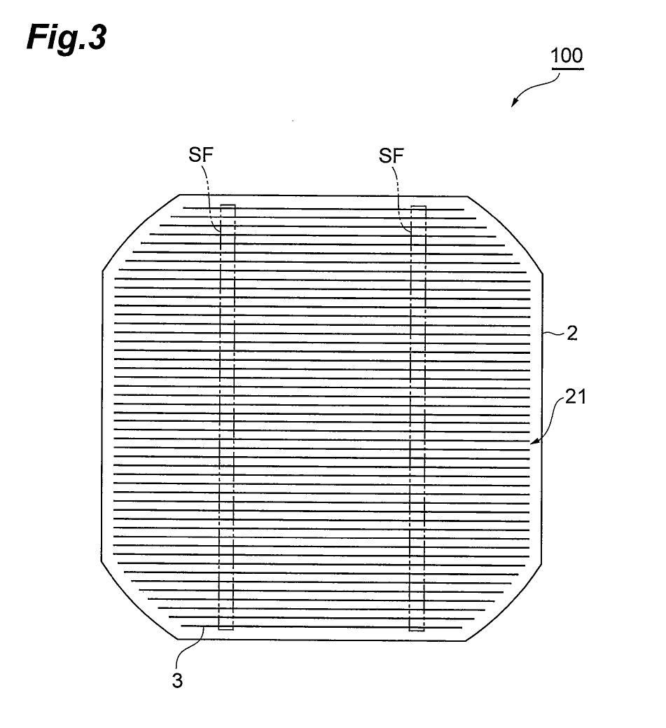

Note that the solar battery cell in FIG. 2 is the one with bus bars (bus bars 6B) being thinned, and the solar battery cell in FIG. 3 is the one with no bus bar provided. In either of these cases, it is possible to connect electrodes of the solar battery cell and wiring members by placing the conductive material in bonding areas SF.

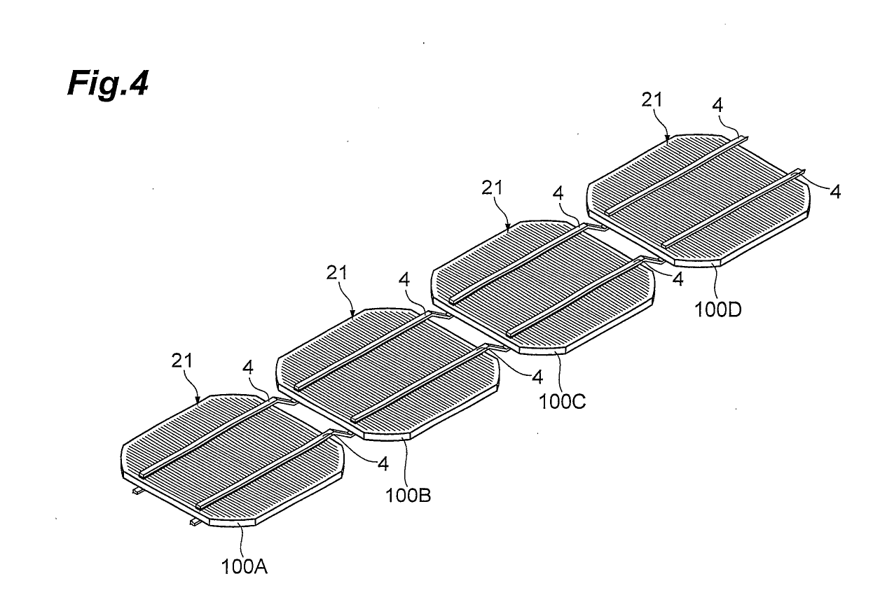

When a plurality of solar battery cells are connected by the above-mentioned method, it is possible to obtain a connected body where the plurality of the solar battery cells are connected, as shown in the schematic perspective view of FIG. 4. In the connected body in FIG. 4, solar battery cells 100A to 100D are connected via wiring members 4, and electrodes of the solar battery cells and the wiring members 4 are connected by the above-mentioned conductive material.

Hereinafter, the present invention will be further described in detail using Examples, however, the present invention is not limited thereto.

<Conductive Particle 1>

A phosphorous-containing copper alloy was prepared, and this alloy was melted, powdered by using a water atomizing method and then dried and classified. The classified powder was blended and subjected to deoxidation/dehydration treatments, thereby producing a phosphorous-containing copper alloy particle (Conductive Particle 1) containing 1% by mass of phosphorous. Note that the average particle diameter (D50) of the phosphorous-containing copper alloy particle was 1.5 μm.

<Conductive Particle 2>

A phosphorous-containing copper alloy was prepared, and this alloy was melted, powdered by using a water atomizing method and then dried and classified. The classified powder was blended and subjected to deoxidation/dehydration treatments, thereby producing a phosphorous-containing copper alloy particle (Conductive Particle 2) containing 6.57% by mass of phosphorous. Note that the average particle diameter (D50) of the phosphorous-containing copper alloy particle was 4.4 μm.

<Conductive Particle 3>

A phosphorous-containing copper alloy was prepared, and this alloy was melted, powdered by using a water atomizing method and then dried and classified. The classified powder was blended and subjected to deoxidation/dehydration treatments, thereby producing a phosphorous-containing copper alloy particle (Conductive Particle 3) containing 7.95% by mass of phosphorous. Note that the average particle diameter (D50) of the phosphorous-containing copper alloy particle was 4.8 μm.

<Conductive Particle 4>

A silver-coated phosphorous-containing copper alloy particle (Conductive Particle 4), in which Conductive Particle 1 was plated with silver to a thickness of 0.1 μm, was produced.

<Conductive Particle 5>

A nickel particle (Conductive Particle 5) having an average particle diameter (D50) of 5 μm, which is commercially available, was prepared.

<Conductive Particle 6>

A silver-coated copper particle (Conductive Particle 6) having a particle diameter of 6 μm, which is commercially available, was prepared. This particle is the one with phosphorous being contained only in an amount of less than 0.01% by mass in copper.

### Example 1

(1) Production of Conductive Material Layer:

A phenoxy resin (polymeric epoxy resin) and a liquid epoxy resin (epoxy equivalent weight: 185) containing a microcapsule-type latent hardening agent were mixed such that a mass ratio of the phenoxy resin to the liquid epoxy resin was 30/70, these components were dissolved in ethyl acetate, and thereby 30% by mass solution in ethyl acetate was obtained.

To this solution, 8% by mass (liquid conductive material total mass basis) of Conductive Particle 1 was added, mixed and dispersed, and thereby a liquid conductive material was obtained. This liquid conductive material was applied to a separator (silicone-treated polyethylene terephthalate film, thickness: 50 μm) by a bar coater, dried at 80° C. for 10 minutes, and thereby a laminate forming a conductive material layer having a thickness of 25 μm was obtained.

Thereafter, this laminate was cut to 1.5 mm width, and thereby a conductive material provided with a conductive material layer (thickness: 25 μm) on a band-like separator was obtained.

(2) Connection:

All bus bars of a solar battery cell (silicon substrate, 125 mm square, thickness: 0.2 mm, the number of bus bars on each of the front surface and the rear surface: 2 pieces) and tab wires (solder-plated copper wire, width: 1.5 mm, thickness: 0.2 mm) were electrically connected with the conductive material, from which the separator had been peeled off, being sandwiched therebetween. As for the connecting method, the individual materials were placed, and then subjected to heating and pressuring by the use of a pressure tool (manufactured by Nikka Equipment & Engineering Co., Ltd., product name: “AC-S300”) under the conditions of heating temperature: 180° C., applied pressure: 2 MPa, and heating/pressuring time: 10 seconds. The tab wires were connected to all the bus bars of the solar battery cell by using the conductive material, thereby obtaining a tab wire-attached solar battery cell.

(3) Evaluation:

An IV curve of the obtained tab wire-attached solar battery cell was measured by using a solar simulator (manufactured by Wacom Electric Co. Ltd., product name: “WXS-155S-10”, AM: 1.5G) to derive a fill factor (hereinafter, abbreviated as F.F). Further, a conversion efficiency (η) was also derived together with F.F at that time. Furthermore, as for the long-term connection stability, before and after a test of exposure to a constant temperature and humidity environment of 85° C. and 85 RH % for 1,000 hours, the case where a fluctuation of the conversion efficiency (η) remained within 5% was considered “Good”, and the case where the fluctuation exceeded 5% was considered “Poor”. The results are shown in Table 1.

### Example 2

A conductive material was obtained in the same manner as in Example 1, except that 4% by mass (liquid conductive material total mass basis) of Conductive Particle 2 was added instead of Conductive Particle 1. Thereafter, connection and evaluations were performed in the same manner as in Example 1. The results are shown in Table 1.

### Example 3

A conductive material was obtained in the same manner as in Example 1, except that 15% by mass (liquid conductive material total mass basis) of Conductive Particle 2 was added instead of Conductive Particle 1. Thereafter, connection and evaluations were performed in the same manner as in Example 1. The results are shown in Table 1.

### Example 4

A conductive material was obtained in the same manner as in Example 1, except that 1% by mass (liquid conductive material total mass basis) of Conductive Particle 3 was added instead of Conductive Particle 1. Thereafter, connection and evaluations were performed in the same manner as in Example 1. The results are shown in Table 1.

### Example 5

A conductive material was obtained in the same manner as in Example 1, except that 9% by mass (liquid conductive material total mass basis) of Conductive Particle 2 was added instead of Conductive Particle 1, and the thickness of a conductive material layer was changed to 35 μm.

Thereafter, connection and evaluations were performed in the same manner as in Example 1, except that a solar battery cell with no bus bar provided on its surface was used. The results are shown in Table 1.

### Example 6

A conductive material was obtained in the same manner as in Example 1, except that 3% by mass (liquid conductive material total mass basis) of Conductive Particle 4 was added instead of Conductive Particle 1. Thereafter, connection and evaluations were performed in the same manner as in Example 1. The results are shown in Table 1.

### Comparative Example 1

A conductive material was obtained in the same manner as in Example 1, except that 10% by mass (liquid conductive material total mass basis) of Conductive Particle 5 was added instead of Conductive Particle 1. Thereafter, connection and evaluations were performed in the same manner as in Example 1. The results are shown in Table 2.

### Comparative Example 2

Connection of the tab wires to a solar battery cell with no bus bar provided on its surface was attempted by using solder. Specifically, tab wires were arranged in series on finger electrodes, and an attempt was made to connect the tab wires to the solar battery cell while supplying solder by a soldering iron set at 300° C. and while melting the solder applied to surfaces of the tab wires, however, lift of tab wires partly occurred, and thus it was impossible to perform the connection.

### Comparative Example 3

A conductive material was obtained in the same manner as in Example 1, except that 10% by mass (liquid conductive material total mass basis) of Conductive Particle 6 was added instead of Conductive Particle 1. Thereafter, connection and evaluations were performed in the same manner as in Example 1. The results are shown in Table 2.

TABLE 1

| Test Name | Example 1 | Example 2 | Example 3 | Example 4 | Example 5 | Example 6 |
|---|---|---|---|---|---|---|
| F.F. | 77.0% | 77.0% | 77.1% | 77.3% | 77.0% | 77.2% |
| η | 15.5% | 15.6% | 15.5% | 15.9% | 15.5% | 15.4% |
| Connection | 180° C. | 180° C. | 180° C. | 180° C. | 180° C. | 180° C. |
| Temperature | | | | | | |
| Long-Term | Good | Good | Good | Good | Good | Good |
| Connection | | | | | | |
| Stability | | | | | | |
| Determination | Good | Good | Good | Good | Good | Good |
| | connection | connection | connection | connection | connection | connection |
| | Economical | Economical | Economical | Economical | Economical | Economical |
| | Environmental | Environmental | Environmental | Environmental | Environmental | Environmental |
| | load - small | load - small | load - small | load - small | load - small | load - small |

TABLE 2

| | Comparative | Comparative | Comparative |
|---|---|---|---|
| Test Name | Example 1 | Example 2 | Example 3 |
| F.F. | 77.0% | Measurement - | 77.2% |
| | | impossible | |
| η | 15.6% | Measurement - | 15.6% |
| | | impossible | |
| Connection | 180° C. | 300° C. | 180° C. |
| Temperature | | | |
| Long-Term | — | — | Poor |
| Connection | | | |
| Stability | | | |
| Determination | Good connection | Poor connection | Good connection |
| | Environmental | | Economical |
| | load - large | | Environmental |
| | | | load - small |

Note that in the above embodiments, as the conductive material, film-shaped conductive material was used, however, a liquid conductive material may be directly applied to a solar battery cell.

What is claimed is:

1. A conductive material used for connecting electrodes of a solar battery cell and wiring members, the conductive material comprising:
a resin binder; and
a conductive particle dispersed in the resin binder,
wherein the conductive particle comprises a phosphorous-containing copper alloy having a phosphorus content of 0.01% by mass or more and 8% by mass or less.

2. The conductive material according to claim 1, wherein an average particle diameter of the conductive particle is 0.4 μm to 30 μm.

3. The conductive material according to claim 1, wherein the conductive particle is a conductive particle produced by using a water atomizing method.

4. The conductive material according to claim 2, wherein the conductive particle is a conductive particle produced by using a water atomizing method.
